(19) United States
(12) Patent Application Publication
(10) Pub. No.: US 2020/0122113 A1
(43) Pub. Date: Apr. 23, 2020

(54) DUAL LASER ELECTROLYTIC CELL

(71) Applicant: IH IP Holdings Limited, St. Helier (JE)

(72) Inventor: Dennis G. Letts, Austin, TX (US)

(21) Appl. No.: 16/703,296

(22) Filed: Dec. 4, 2019

Related U.S. Application Data
(63) Continuation of application No. PCT/US18/36366, filed on Jun. 7, 2018.
(60) Provisional application No. 62/516,384, filed on Jun. 7, 2017.

(51) Int. Cl. B01J 19/12; C25B 15/00; C25B 1/04

(52) U.S. Cl. CPC B01J 19/121; B01J 2219/12; C25B 1/04; C25B 15/00

(57) ABSTRACT

Methods and apparatus are disclosed for triggering an exothermic reaction in an electrolytic cell using two lasers configured at pre-determined triggering frequencies. The triggering frequencies are determined based on one or more resonant frequencies characteristic of the metal hydride coated on one of the electrodes of the electrolytic cell. Excess power output in the range of 200 through 500 mW is observed when an exothermic reaction is triggered in a dual laser electrolytic cell.

### CROSS-REFERENCE TO RELATED APPLICATIONS

This application is a continuation of International application No. PCT/US18/36366, filed on Jun. 7, 2018, entitled “DUAL LASER ELECTROLYTIC CELL”, which claims priority to U.S. Provisional Patent Application No. 62/516,384 filed on Jun. 7, 2017, entitled “DUAL LASER ELECTROLYTIC CELL.”

### TECHNICAL FIELD

The present disclosure relates generally to triggering an exothermic reaction, and specifically to using two laser beams to trigger an exothermic reaction in an electrolytic cell.

### BACKGROUND

Prior studies have shown that certain electrolytic cells can produce excess heat that cannot be attributed to chemical reactions. For example, U.S. Pat. No. 5,635,038 teaches an electrolytic cell with specially fabricated electrodes and using the electrolytic cell for excess heat production. The electrodes of the electrolytic cell are plated with multiple layers of metals, e.g., palladium and nickel. In one example, the cathode is plated with palladium to form a heat-producing hydride.

However, U.S. Pat. No. 5,636,038 does not disclose a triggering method for initiating an exothermic reaction. Lack of reproducibility has long been a problem in the field of excess heat production using electrolytic cells. Reliable triggering methods are needed to demonstrate reproducibility and consistency.

The present disclosure teaches methods and apparatus for triggering excess heat generation in an electrolytic cell.

### SUMMARY

The present disclosure teaches methods and apparatus for triggering an exothermic reaction in a dual laser electrolytic cell.

In some embodiments, the dual laser electrolytic cell comprises an electrolytic cell, a first laser, and a second laser. The electrolytic cell comprises an electrolyte, a cathode and an anode. In one embodiment, the electrolyte comprises heavy water and lithium deuterium oxide (LiOD) dissolved in the heavy water. The first laser is tuned at a first frequency. The second laser is tuned at a second frequency. The first laser and the second laser are both configured to irradiate the cathode. The second frequency is higher than the first frequency by a pre-determined beat frequency. In this disclosure, the difference between the first frequency and the second frequency is also referred to as beat frequency. In one embodiment, the light from the first and second lasers are linearly polarized. The polarization of the first laser and that of the second laser may be aligned. Experiments have shown that anomalous heat can be produced when the polarization of the magnetic field and that of the first and/or second lasers are at an angle with respect to each other with the maximum heat generation occurring when the angle is 90 degrees. In one embodiment, the pre-determined beat frequency is one of the following three resonant frequencies: 8.3 THz, 15.3 THz, and 20.4 THz. In one embodiment, the electrolytic cell comprises a magnetic device configured to apply a magnetic field inside the electrolytic cell. The magnitude of the magnetic field is around 500-700 Gauss.

In some embodiments, an electrolytic cell is configured for excess heat generation. The electrolytic cell comprises an electrolyte, a cathode, an anode, and two lasers: a first and second laser. The two lasers are configured to irradiate the cathode with laser beams of pre-determined frequencies. The electrolyte may comprise heavy water and lithium deuterium oxide (LiOD) dissolved in the heavy water. The method of triggering the electrolytic cell to initiate excess heat generation comprises setting the first and second lasers to pre-determined frequencies and triggering an exothermic reaction to generate excess heat by casting the laser beams on the cathode of the electrolytic cell. In some embodiments, the first laser is tuned to a first frequency and the second laser is tuned to a second frequency that is higher than the first frequency by a pre-determined beat frequency. In one embodiment, the pre-determined beat frequency is one of the following three resonant frequencies: 8.3 THz, 15.3 THz, and 20.4 THz. In one embodiment, a magnetic device is configured to apply a magnetic field inside the electrolytic cell. The magnitude of the magnetic field is around 500-700 Gauss. In one embodiment, the light beams from the two lasers are linearly polarized. The polarization of the two light beams may be aligned. The polarization of the two aligned light beams may be configured to be at an angle with respect to the polarization of the magnetic field.

### BRIEF DESCRIPTION OF FIGURES

FIG. 1 illustrates an exemplary electrolytic cell.

FIG. 2 illustrates an exemplary electrolytic cell equipped with two triggering lasers.

FIG. 3a lists three resonant frequencies characteristic of palladium deuteride.

FIG. 3b illustrates excess power outputs from different exothermic reactions as a function of the beat frequency between two triggering lasers.

FIG. 4 illustrates the excess power output and the beat frequency between the triggering lasers recorded as a function of time in an exemplary exothermic reaction.

FIG. 5a illustrates a scan up from 19.4 to 23.5 THz, showing an excess power trigger point at 20.07 THz.

FIG. 5b illustrates another test result in which the beat frequency is scanned down from 21.5 to 18.3 THz.

FIG. 6 illustrates the excess power output and the beat frequency between the two triggering lasers recorded as a function of time in a second exemplary exothermic reaction.

FIG. 7a shows that the beat frequency between the two lasers scans a frequency range between 3 THz and 7 THz.

FIG. 7b shows that, when the beat frequency is set to 8.75 THz at time 668, the excess power is zero.

FIG. 8 is a flow chart illustrating an exemplary method of triggering an exothermic reaction in an electrolytic cell using dual lasers.

### DETAILED DESCRIPTION

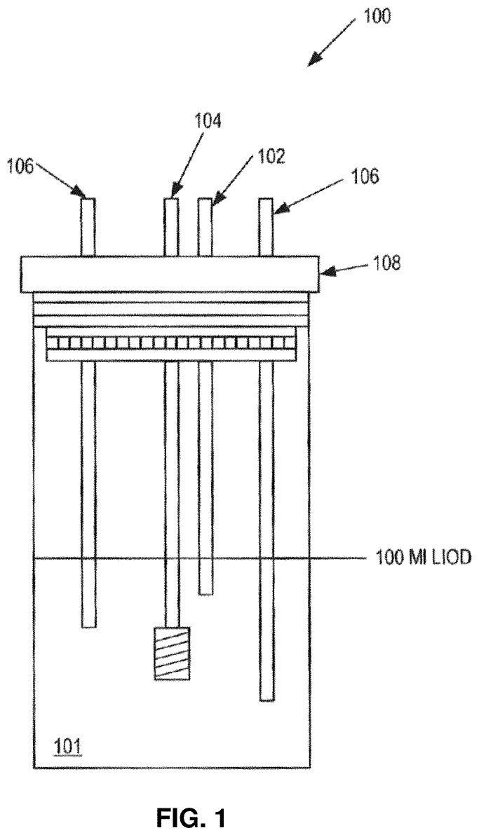

In referring to FIG. 1, an exemplary electrolytic cell 100 comprises a container 101, a lid 108, an anode 102, a cathode 104, and two thermistors 106. The container 101 holds an electrolyte. In one embodiment, the electrolyte comprises heavy water and lithium deuterium oxide (LiOD) dissolved in the heavy water. The cathode 104 is made of palladium. In general, an electrolytic cell utilizes the energy from an applied voltage to drive a chemical reaction. In the electrolytic cell 100, the anode 102 is connected to the positive terminal of a DC power supply and the cathode 104 is connected to the negative terminal. A current runs from the anode 102 to the cathode 104 through the electrolyte that comprises heavy water. The electric current running through the electrolyte decomposes the heavy water into D₂ and O₂ gases.

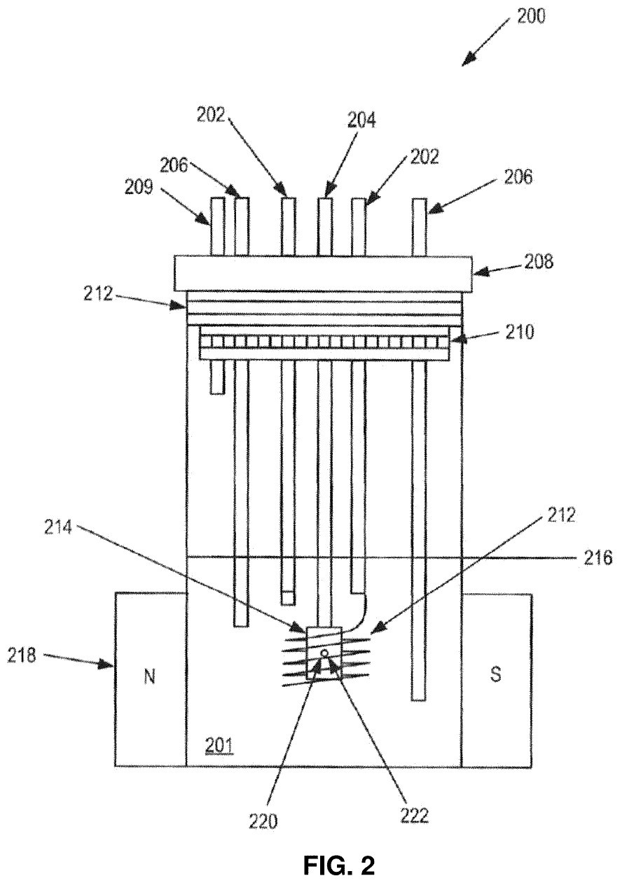

FIG. 2 illustrates a more elaborate electrolytic cell 200 configured for excess heat generation. The electrolytic cell 200 comprises a container 201, anodes 202, a cathode 204, thermistors 206, a lid 208, and a vent 209. The electrolytic cell 200 further comprises one or more magnets 218 that generate a magnetic field inside the electrolytic cell 200. In one embodiment, the magnitude of the magnetic field is around 625 Gauss.

The container 201 of the electrolytic cell 200 contains an electrolyte that comprises heavy water and LiOD dissolved in the heavy water. The cathode 204 is plated with gold (Au). On the cathode 204, the end that is immersed in the electrolyte may be plated with palladium (Pd) or may be a bulk palladium foil 214. Cathodes that are plated with palladium are first plated with a substrate of gold. Bulk palladium foils are first loaded with deuterium for a predetermined period of time and then over-plated with gold prior to laser stimulation. A platinum wire 212 extended from one end of the anodes 202 is coiled around the palladium cathode 214 with a minimum spacing to prevent electrical shorting between anode and cathode. In one embodiment, a DC current of 50 mA is applied to load the cathode with deuterium for a predetermined period of time.

In some embodiments, the lid 208 in the electrolytic cell 200 is made of Teflon. To improve sealing and prevent leaking, the lid 208 is also fitted with an O-ring seal. The lid 208 further comprises re-combiners 210 that catalyze the recombination of D₂ and O₂ into heavy water for re-use in the cell.

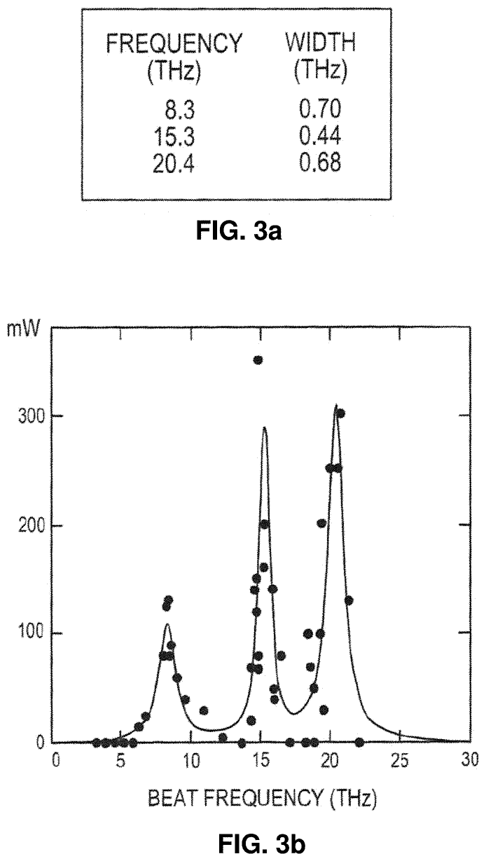

As shown in FIG. 2, two lasers, 220 and 222, are tuned at pre-determined frequencies and are configured to irradiate the palladium cathode 214 with light beams of the pre-determined frequencies, respectively. In some embodiments, the difference between the frequencies of the two light beams is set to be a resonant frequency that is characteristic of the metal deuteride, e.g., palladium occluded with deuterium, formed on the surface of the cathode 214. For example, in palladium deuteride, the three resonant frequencies are 8.3 THz, 15.3 THz, and 20.4 THz, as listed in FIG. 3a.

In some embodiments, the two lasers, 220 and 222, are configured according to the following procedure. First, the first laser, e.g., laser 220, is tuned to a first predetermined frequency. Then, the second laser, e.g., laser 222, is tuned to a second predetermined frequency. In the case of palladium deuteride, the second predetermined frequency is selected by adding one of the three resonant frequencies listed in FIG. 3a to the first pre-determined frequency.

FIG. 3b illustrates the excess power outputs from a series of tests performed in the electrolytic cell 200 when the two lasers 220 and 222 are configured as described above. In FIG. 3b, each black dot represents a result from a test performed in the electrolytic cell 200. Each test result shows the beat frequency used in the test and the excess power output generated by the electrolytic cell 200. As shown in FIG. 3b, when the beat frequency is set to one of the three resonant frequencies, the excess power output by the electrolytic cell is the largest. When the beat frequency is close to one of the three resonant frequencies, substantial excess heat generation can still be observed but the thermal power output is less than optimum. For example, as shown in FIG. 3b, the beat frequency in six of the tests is approximately 8.3 THz, one of the resonant frequencies associated with deuterium-occluded palladium. The six tests show substantial amount of excess heat. Among these six tests, the excess power output in two of them, in which the beat frequency is closest to 8.3 THz, is the largest, around 120 mW. Similarly, in eleven of these tests, the beat frequency between the two lasers 220 and 222 is set to approximately 15.3 THz, another resonant frequency associated with deuterium-occluded palladium. In these tests, significant amount of excess heat output is measured in the electrolytic cell 200. For example, when the beat frequency is set in the frequency range of 15 THz±0.22 THz, the excess power output from the electrolytic cell 200 ranges from 50 mW to 200 mW. The test results show similar outcomes when the beat frequency of the two lasers 220 and 222 is set to 20.4 THz, the third resonant frequency associated with deuterium-occluded palladium. In those tests, anomalous amounts of excess heat are observed in at least seven experiments. For example, when the beat frequency is set in the frequency range of 20.4 THz±0.68 THz, the excess power output from the electrolytic cell 200 ranges from 100 mW to 300 mW.

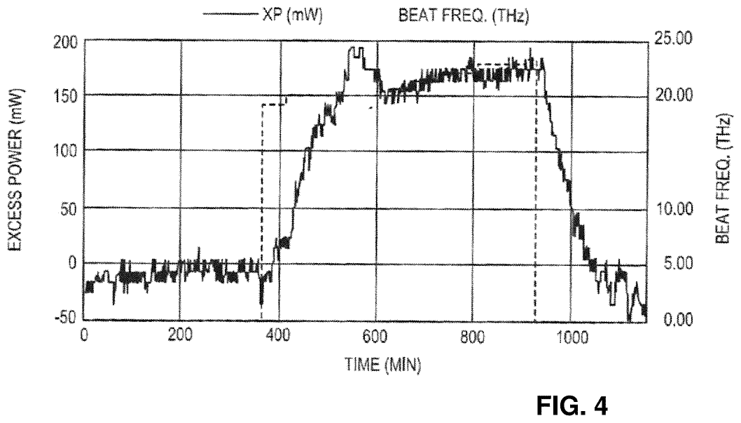

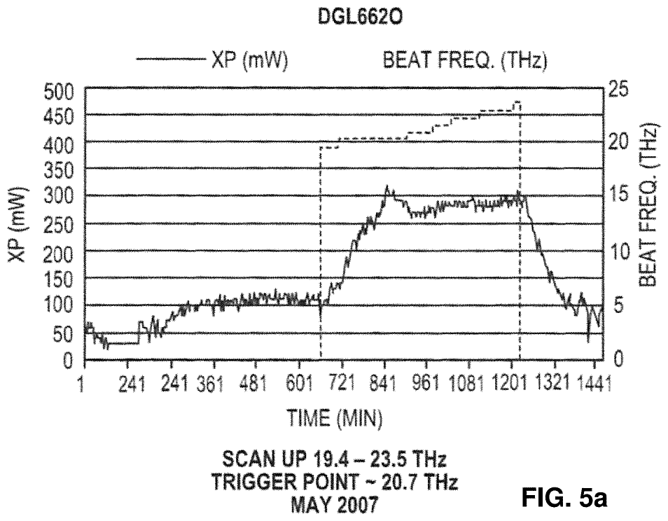

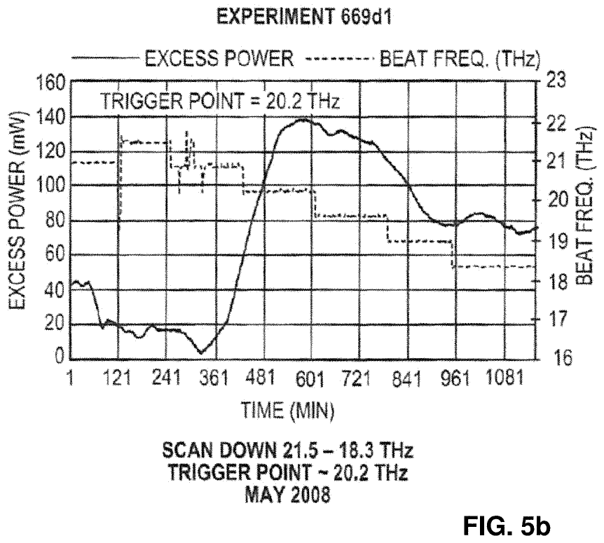

FIG. 4 illustrates an exemplary test result that shows the excess power output from the electrolytic cell 200 and the beat frequency between the laser 220 and the laser 222 is set to 20.4 THz, both plotted against the lapsed time. In FIG. 4, between time 0 and time 380 Min, the beat frequency is zero, which can be arranged by turning both lasers off. During this time period, the average excess power output is approximately zero mW. At time 380 Min, both lasers were turned on with the beat frequency set to approximately 20.4 THz. Afterwards, the excess power output from the electrolytic cell 200 gradually increases from zero mW to 150 mW. For a time period of 520 minutes, from time 380 Min to 900 Min, when the beat frequency is set to 20.4 THz, the excess power output from the electrolytic cell 200 is maintained at around 150 mW. At time 900 Min, the beat frequency is reset to 0 THz by, e.g., by turning the lasers off. The excess power output from the electrolytic cell 200 gradually declines and returns to 0 mW after a period of 200 minutes. FIGS. 5a and 5b illustrate the results of two exemplary tests in which the beat frequency between the two lasers 220 and 222 is set close to 20 THz. FIG. 5a illustrates a scan up from 19.4 to 23.5 THz, showing an excess power trigger point at 20.07 THz. FIG. 5b illustrates another test result in which the beat frequency is scanned down from 21.5 to 18.3 THz. The excess power trigger point was 20.2 THz. The trigger points occur at essentially the same beat frequency and the experiments were conducted one year apart. Compared to FIG. 5a, the excess power output in FIG. 5b is noticeably increased after the beat frequency between the two lasers 220 and 222 reached 20.2 THz. As shown in both FIG. 5a and FIG. 5b, after the beat frequency reached the resonant frequency slightly greater than 20 THz, it takes approximately 200 minutes for the excess power output to ramp up. In FIG. 5a, the amount of excess power output increase is about 150 mW. In FIG. 5b, the amount of excess power output increase is around 140 mW. Both figures show significant increases of excess power output when the two lasers 220 and 222 are so configured that the beat frequency between the two lasers is set to a resonant frequency slightly greater than 20 THz.

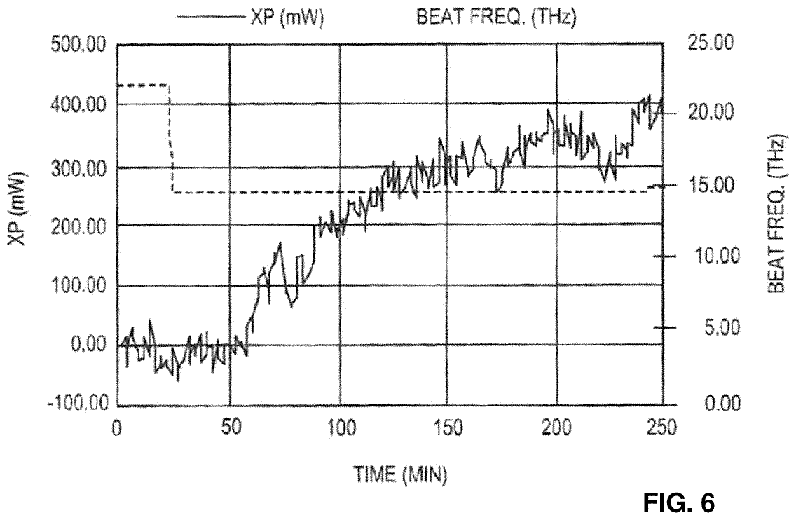

FIG. 6 illustrates an exemplary test result when the beat frequency between the two lasers 220 and 222 is set to 15.3 THz. From time 0 Min to 25 Min, no excess power is produced when the beat frequency is set to 20.4 THz. In one theory, the beat frequency of 20.4 THz is conjectured to be in resonance with the vibrational bonds of D-H. If there is a low concentration of light hydrogen (H) in the deuterated lattice, the 20.4 THz signal will not trigger observable excess power. However, when the concentration of H in the deuterated palladium lattice exceeds a threshold, excess power can become observable at the beat frequency of 20.4 THz.

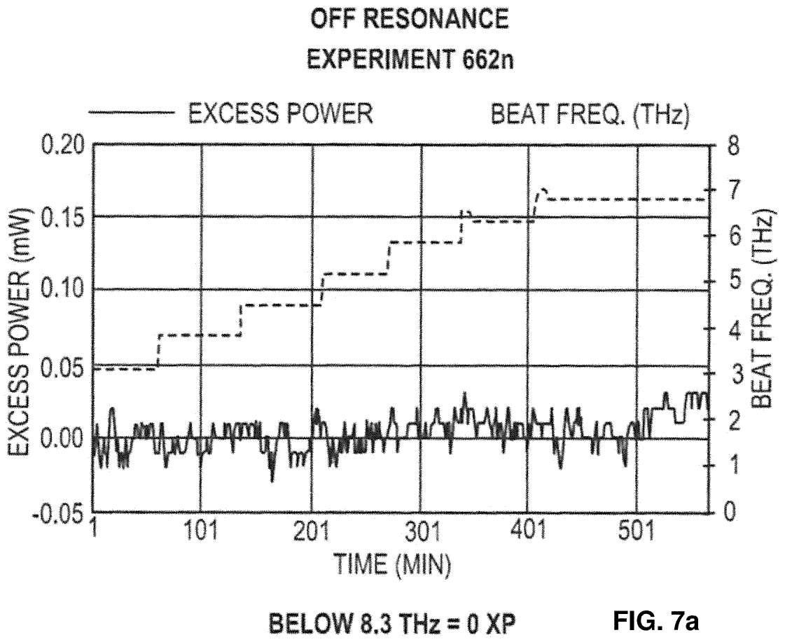

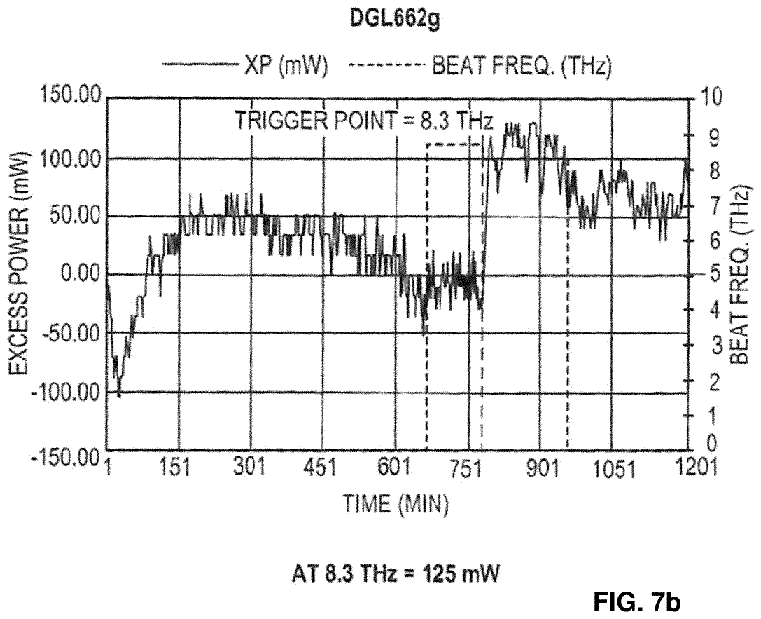

At time 25 Min, the two lasers are reconfigured and the beat frequency is reset to 15.3 THz, reduced from 20.4 THz. From this point in time onward, the excess power output from the electrolytic cell 200 gradually increases from zero mW to about 400 mW in a time period of approximately 200 minutes. The excess power output remains positive for this entire period during which the beat frequency is set to 15.3 THz. FIGS. 7a and 7b illustrate a comparison between the results of two tests, in which one is off resonance and one is on resonance. In FIG. 7a, the beat frequency between the two lasers scans a frequency range between 3 THz and 7 THz. The beat frequency stays below 8 THz. During the scanning, the beat frequency between the two lasers 220 and 222 does not equal any of the three resonant frequencies listed in FIG. 3a. The excess power output from the electrolytic cell remains approximately 0 mW with an error margin of 10 mW. In FIG. 7b, when the beat frequency is set to 8.75 THz at time 668, the excess power is zero. At time 780 the beat frequency was set to 8.3 THz and the excess power output from the electrolytic cell 200 increases sharply from around 0 mW to around 125 mW. The excess power output remains at approximately 125 mW until the beat frequency is turned off from which point onward the excess power output declined noticeably.

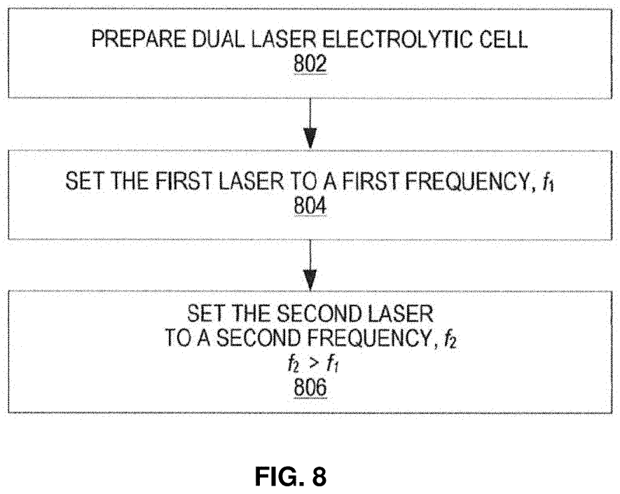

As shown in the test results illustrated in FIGS. 4-7b, excess heat is generated in the electrolytic cell 200 when the beat frequency between the two lasers 220 and 222 is set to one of the resonant frequencies. FIG. 8 is a flow chart showing an exemplary method for configuring an electrolytic cell 200 in preparation of excess heat generation. The exemplary method in FIG. 8 comprises three steps. In step 802, a dual laser electrolytic cell 200 is prepared. The dual laser electrolytic cell 200 comprises a cathode 204, an anode 202, an electrolyte and two lasers 220 and 222, with two external magnets 218 placed adjacent to the electrolytic cell 200. In step 804, the first laser 220 is set to a first frequency, f₁. In step 806, the second laser 222 is set to a second frequency, f₂. The second frequency, f₂, is higher than the first frequency, f₁. The difference between these two frequencies is set to approximately one of the resonant frequencies that are characteristic of the materials plated on the cathode 204. When the two lasers are tuned and the two laser beams are cast upon on the cathode 204, an exothermic reaction can be triggered in the electrolytic cell 200.

The present invention may be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

1. An apparatus for generating excess heat, comprising:
an electrolytic cell, wherein the electrolytic cell includes an electrolyte, a cathode and an anode;
a first laser configured for operating at a first frequency; and
a second laser configured for operating at a second frequency;
wherein the first laser and the second laser are both configured to emit light upon the cathode, and wherein the second frequency is higher than the first frequency.

2. The apparatus of claim 1, wherein the second frequency is higher than the first frequency by a pre-determined amount, wherein the pre-determined amount between the second frequency and the first frequency is one of the following three beat frequencies: 8.3 THz, 15.3 THz, 20.4 THz.

3. The apparatus of claim 1, further comprising a magnetic device configured to apply a magnetic field inside the electrolytic cell.

4. The apparatus of claim 3, wherein the magnitude of the magnetic field is around 500-700 Gauss.

5. The apparatus of claim 3, wherein light beams from the first and second laser are linearly polarized and wherein the polarization of the light beam of the first laser and the polarization of the light beam of the second laser are aligned.

6. The apparatus of claim 5, wherein the polarization of the magnetic field and the polarization of the light beams of the first or second lasers are at an angle to the magnetic field polarization.

7. The apparatus of claim 6, wherein the angle between the polarization of the light beams of the first or second lasers and the polarization of the magnetic field is 90 degrees.

8. The apparatus of claim 1, wherein the electrolyte comprises heavy water and LiOD dissolved in the heavy water.

9. A method of generating excess heat using an electrolytic cell, said electrolytic cell comprising an electrolyte, a cathode, an anode, a first laser, and a second laser, said method comprising:
positioning the first laser and the second laser to cast light upon the cathode;
setting the first laser to a first frequency; and
setting the second laser to a second frequency, wherein the second frequency is higher than the first frequency.

10. The method of claim 9, wherein the second frequency is higher than the first frequency by a pre-determined amount, wherein the pre-determined amount between the second frequency and the first frequency is one of the following three beat frequencies: 8.3 THz, 15.3 THz, 20.4 THz.

11. The method of claim 9, wherein a magnetic device is configured to apply a magnetic field inside the electrolytic cell.

12. The method of claim 11, wherein the magnitude of the magnetic field is around 500-700 Gauss.

13. The method of claim 11, wherein light beams from the first and second laser are linearly polarized and wherein the polarization of the light beam of the first laser and the polarization of the light beam of the second laser are aligned.

14. The method of claim 13, wherein the polarization of the magnetic field and the polarization of the light beam of the first or the second lasers are at an angle.

15. The method of claim 14, wherein the angle between the polarization of the light beam of the first laser beam or the second laser beam and the polarization of the magnetic field is 90 degrees.

16. The method of claim 9, wherein the electrolyte comprises heavy water and LiOD dissolved in the heavy water.

17. An apparatus for generating excess heat, comprising:
an electrolytic cell, wherein the electrolytic cell includes an electrolyte, a cathode and an anode;
a palladium foil positioned on the cathode;
a first laser configured for operating at a first frequency; and
a second laser configured for operating at a second frequency;
wherein the first laser and the second laser are both configured to emit light upon the cathode, and wherein the second frequency is higher than the first frequency.

18. The apparatus of claim 17, wherein the electrolyte comprises heavy water and LiOD dissolved in the heavy water.

19. The apparatus of claim 17, wherein the cathode is plated with a substrate of gold before being plated with palladium.

20. The apparatus of claim 17, wherein the palladium foil is loaded with deuterium and over-plated with gold.

21. The apparatus of claim 17, wherein a DC current of 50 mA is applied to load the cathode with deuterium.
